(19) United States
(12) Patent Application Publication
(10) Pub. No.: US 2026/0003612 A1
(43) Pub. Date: Jan. 1, 2026

(54) FACILITATION OF SOFTWARE COMPONENT SOFTWARE SUPPORT DOCUMENT LINKS VIA MACHINE LEARNING

(71) Applicant: SAP SE, Walldorf (DE)

(72) Inventors: Sven LIEBIG, Wiesloch (DE); Laura BRAKE, Wiesloch (DE); Daniel MAYER, Rehlingen-Siersburg (DE); Sudhir VERMA, Gurgaon (IN)

(21) Appl. No.: 18/760,167

(22) Filed: Jul. 1, 2024

(51) Int. Cl. G06F 8/73

(52) U.S. Cl. CPC G06F 8/73

(57) ABSTRACT

A support document data store contains multiple support documents for a software component (including a support document identifier and descriptive text). A missing link server automatically identifies some support documents as being potential solving support documents. For each potential solving support document, a machine learning analysis of the descriptive text is performed to generate a link probability. For each document having a link probability above a threshold, a potential link message is automatically generated that includes the document identifier and an associated causing support document identifier. According to some embodiments, potential link messages are compiled into a potential link report for review by a developer to classify them as an actual link or not an actual link. A support document link data store may include indications of causing support documents with an associated links to solving support documents.

### BACKGROUND

An enterprise, such as a cloud application provider, may use support documents to update and track application changes and corrections. For example, FIG. 1 is an illustration 100 associated with software component support where support documents “SD1234” and “SD2468” (each including a document identifier and text description of the document) that may be associated with a software component 110 patch. In some cases, a support document may introduce a new error or problem (e.g., a “side effect”) which is referred to herein as a causing support document 120. For example, causing support document 120 introduced an error that needed to be fixed by a software patch associated with “SD5678” (referred to herein as a solving support document 122). Note that “SD5678” also introduced an error that needed to be corrected by “SD9876.” Thus, “SD5678” is both a solving support document and a causing support document. Also note that some support documents 124, such as “SD3579,” may be neither a solving nor causing support document (e.g., the support document 124 may describe another support document without including a software patch).

A table 130 (e.g., with dedicated database links) may be updated by a software developer to help keep track of the links between causing support documents and solving support documents. This information may be used in numerous ways, for instance if a customer tries to implement a causing support document, the system might automatically suggest implementing an associated solving support document. There might also be an automated service that detects if a customer system has implemented a causing support document without implementing an associated solving support document (and the customer can then be notified about the known issue).

Sometimes a developer of a solving support document forgets to maintain the table 130. For example, FIG. 2 is another illustration 200 associated with software component support. This illustration 200 includes multiple software components 210 with associated support documents 220. Moreover, a single causing support document “SD5555” is associated with multiple solving support documents “SD6666” and “S37777.” Moreover, a software developer has neglected to record a connection between “SD5678” and “SD9876” in a link table 230. That is, the table is missing the appropriate link. In this case, any automated checks built on the relationship will no longer work. This can cause a variety of issues, since customers will encounter issues that have already been solved. Usually, the customer will open a new support ticket which will cost both the customer and the enterprise time and money. To avoid this, software developers might manually review support document description to identify missing links. However, such a manual review may be time consuming and error-prone task, especially when a substantial number of software components and support documents are involved (e.g., an enterprise might have hundreds of thousands of support documents).

It would therefore be desirable to provide improved ways to facilitate support document links in a secure, automatic, and efficient manner.

### SUMMARY

According to some embodiments, methods and systems associated with software component support may include a support document data store that contains multiple support documents for a software component (including a support document identifier and descriptive text). A missing link server automatically identifies some support documents as being potential solving support documents. For each potential solving support document, a machine learning analysis of the descriptive text is performed to generate a link probability. For each document having a link probability above a threshold, a potential link message is automatically generated that includes the document identifier and an associated causing support document identifier. According to some embodiments, potential link messages are compiled into a potential link report for review by a developer to classify them as an actual link or not an actual link. A support document link data store may include indications of causing support documents with associated links to solving support documents.

Some embodiments comprise: means for automatically identifying, by a computer processor of a missing link server a subset of support documents in a support document data store as being potential solving support documents, wherein the support document data store contains a plurality of support documents for at least one software component, each support document including a support document identifier and descriptive text describing the support document; for each potential solving support document, means for automatically performing a machine learning analysis of the associated descriptive text to generate a link probability; and for each potential solving support document having a link probability above a threshold, means for automatically generating a potential link message that includes the potential solving document identifier and an associated causing support document identifier.

Some technical advantages of some embodiments disclosed herein are improved systems and methods to facilitate support document links in a secure, automatic, and efficient manner.

### BRIEF DESCRIPTION OF THE DRAWINGS

FIG. 1 is an illustration associated with software component support.

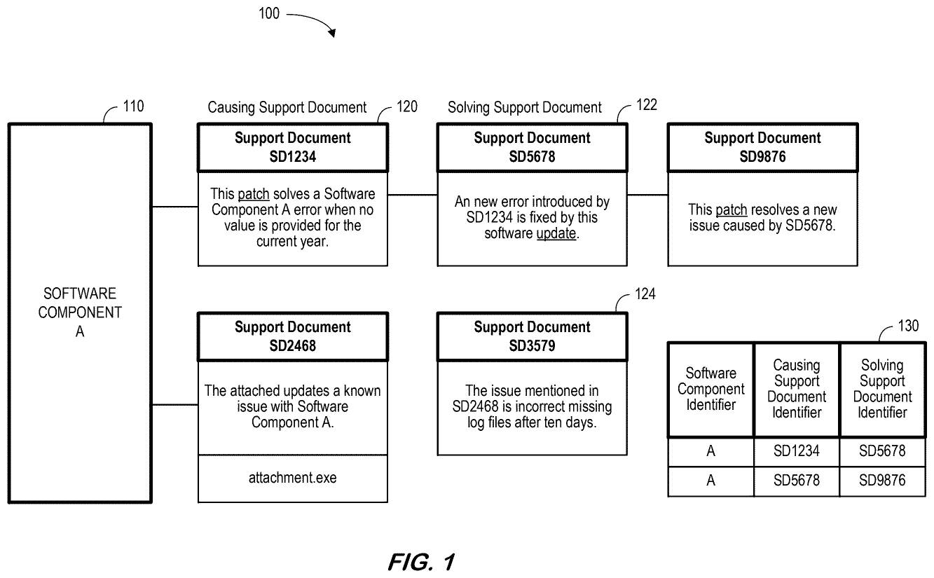

FIG. 2 is another illustration associated with software component support.

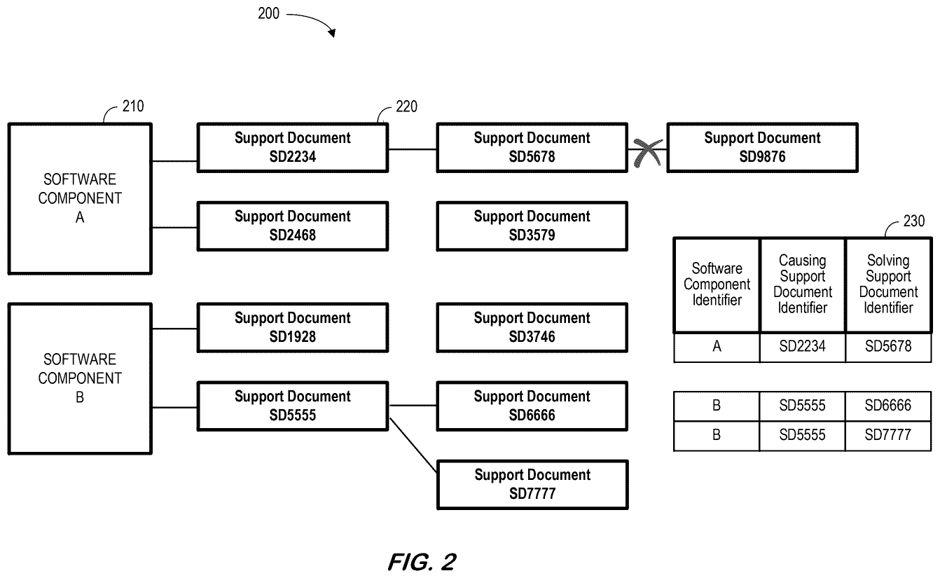

FIG. 3 is a high-level architecture of a system according to some embodiments.

FIG. 4 is a method in accordance with some embodiments.

FIG. 5 is an overview of major machine learning building block components according to some embodiments.

FIG. 6 is an example of a machine learning algorithm for context detection in accordance with some embodiments.

FIG. 7 illustrates machine learning training data according to some embodiments.

FIG. 8 illustrates machine learning via consecutive training steps in accordance with some embodiments.

FIG. 9 is a missing link report according to some embodiments.

FIG. 10 is a missing link workflow in accordance with some embodiments.

FIG. 11 is a customer suggestion method according to some embodiments.

FIG. 12 is a customer suggestion display in accordance with some embodiments.

FIG. 13 is a customer landscape alert method according to some embodiments.

FIG. 14 is a customer landscape alert architecture in accordance with some embodiments.

FIG. 15 is a customer landscape alert display according to some embodiments.

FIG. 16 is an apparatus or platform according to some embodiments.

FIG. 17 is a portion of a support document data store in accordance with some embodiments.

FIG. 18 is a portion of a support document link data store in accordance with some embodiments.

FIG. 19 illustrates a tablet computer according to some embodiments.

FIG. 20 is an operator or administrator display in accordance with some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Note that a causing support document is often mentioned (e.g., using a document identifier) in the textual description of the solving support document. Some embodiments described herein find potential candidates that might have a missing link by scanning the document text for document identifiers and using a machine learning algorithm (e.g., including Natural Language Processing (“NLP”)) to determine if the identifier appears in a context that points to a corrected side effect. These candidates can then be reviewed by component experts who decide if the missing side effect was detected correctly. For correctly detected missing side effects, the experts add the missing side effect link for the solving support documents.

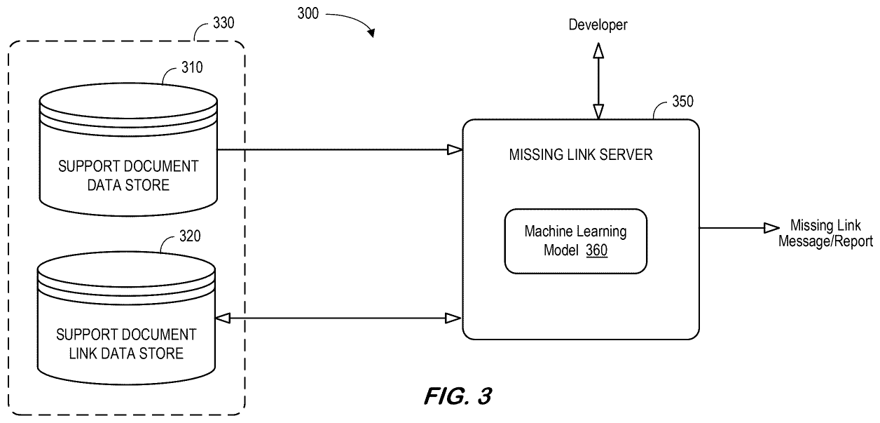

FIG. 3 is a high-level block diagram of one example of a system 300 associated with a software component provider in which a support document data store 310 and support document link data store 320 exchange information with a missing link server 350. In particular, the missing link server 350 may receive support documents (including identifiers, descriptive text, and patches) from the support document data store 310. The support documents may be associated with, for example, software components. Note that in some embodiments, the support document data store 310 and the support document link data store 320 may comprise a single data store 330.

As used herein, devices, including those associated with the system 300 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The missing link server 350 may store information into and/or retrieve information from various data stores (e.g., the support document data store 310), which may be locally stored or reside remote from the missing link server 350. Although a single missing link server 350 is shown in FIG. 3, any number of such devices may be included. Moreover, various devices described herein might be combined according to embodiments of the present invention. The system 300 functions may be performed by a constellation of networked apparatuses, such as in a distributed processing or cloud-based architecture.

An operator or administrator may access the system 300 via a remote device (e.g., a Personal Computer (“PC”), tablet, or smartphone) to view information about and/or manage operational information in accordance with any of the embodiments described herein. In some cases, a User Interface (“UI”) may let an operator, administrator, or developer define and/or adjust certain parameters via a remote device (e.g., to specify parameters for a machine learning model 360) and/or provide or receive automatically generated recommendations, messages, reports, alerts, or results associated with the system 300.

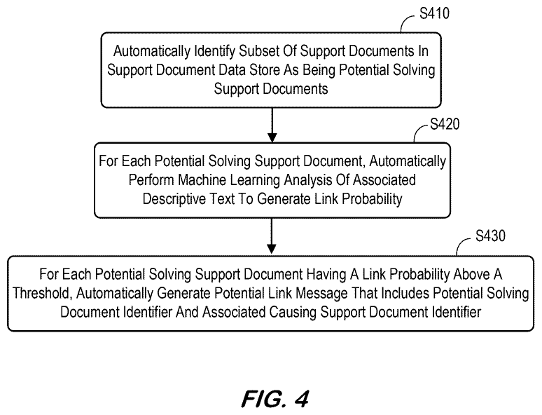

FIG. 4 is a method according to some embodiments. The flow charts described herein do not imply a fixed order to the steps, and embodiments of the present invention may be practiced in any order that is practicable. Note that any of the methods described herein may be performed by hardware, software, an automated script of commands, or any combination of these approaches. For example, a computer-readable storage medium may store thereon instructions that when executed by a machine result in performance according to any of the embodiments described herein.

At S410, a subset of support documents in a support document data store is automatically identified as being potential solving support documents. The support document data store may, for example, contain a plurality of support documents for at least one software component (with each support document including a support document identifier and descriptive text describing the support document). In some embodiments, the identification of the potential solving support documents involves detection of at least one support document identifier in the descriptive text (e.g., a series of characters in the form of “SD ####”). For example, at least some of the support documents in the support document data store may further include information about a software patch for the at least one software component. In this case, a solving support document may include information about a software patch to be installed for a software application after a patch associated with an associated causing support document is installed. In some embodiments, multiple potential link messages are compiled into a potential link report for review by a developer to be classified as, for example, an actual link, not an actual link, unresolved, etc.

For each potential solving support document, at S420 the system may automatically perform a machine learning analysis of the associated descriptive text to generate a link probability. For each potential solving support document having a link probability above a threshold, at S430 the system may automatically generate a potential link message that includes the potential solving document identifier and an associated causing support document identifier. According to some embodiments, these can then be manually reviewed by software developers.

As previously mentioned, sometimes the developer of a solving support document forgets to maintain the side effect link, referred to as the “missing link problem.” When the link on database level is missing for these support documents, the causing support document might still be mentioned in the text description of the solving support document. This text occurrence provides an opportunity to identify missing links by checking the text descriptions. Note that a manual review of all support documents to find missing links might not be feasible when a substantial number of documents and excessive amounts of text need to be checked by developers. To solve this problem, embodiments may utilize an algorithm that scans all support document text descriptions and selects only notes that have a high probability of being associated with missing side effect links. The number of these candidates may be, for example, about one percent of the initial number of support documents. This substantially reduces the effort for the necessary manual checks resulting in a more reasonable amount. The developers can then verify if the detected candidates are indeed missing links and then update the link in the database field accordingly.

Some embodiments use an algorithm that first fetches the relevant data from a support document database. The text is scanned for a support document identifier pattern (e.g., six or seven digit numbers in the text or any other recognizable sequence of characters). For every occurrence of such an identifier, a machine learning algorithm analyzes the text near the identifier. The machine learning algorithm returns a probability that indicates a likelihood that the text is referring to a missing link. The entries with large probabilities are selected (referred to as candidates and a list of these candidates is exported (e.g. to an application spreadsheet such as MICROSOFT™ EXCEL® file which is shared with software developers. The developers can then use this file for manual missing link checks (and may also provide feedback in additional fields if necessary).

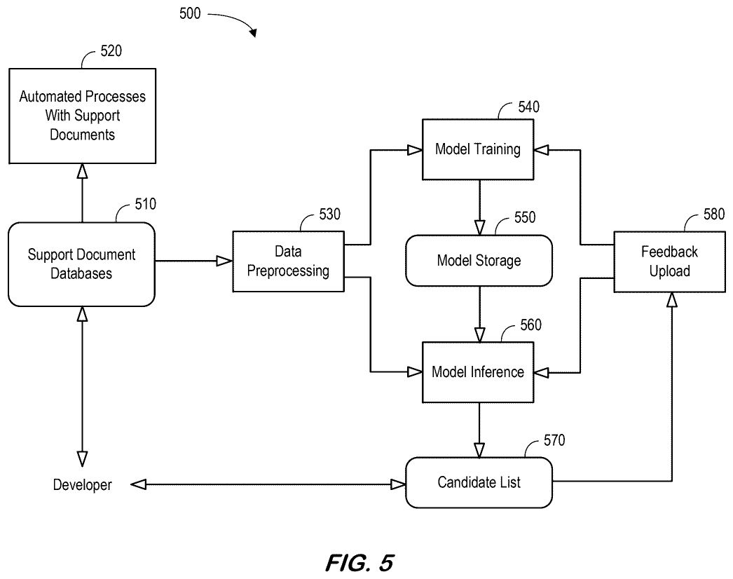

FIG. 5 is an overview 500 of major machine learning building block components according to some embodiments. Information from support document databases 510 may be used, for example, to support automated processes with support documents 520 (e.g., to recommend potentially relevant support documents to customers). Data preprocessing 530 may be used for model training 540 to create a trained model that is sent to model storage 550 for use by model inference 560. The model inference 560 results are then used to create a candidate list 570 for developer review (and the experts may update the support document databases 510 when necessary). The improved data quality and consistency is then consumed by the automated processes 520 that are based on the side effect link. Feed back from developers may also be uploaded 580 to improve the model training 540 and/or the model inference.

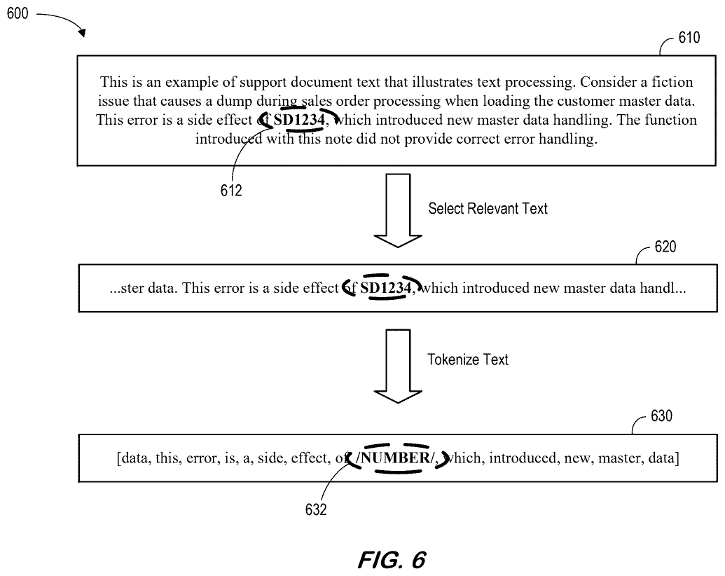

The data preprocessing 530 may analyze support document text descriptions. For example, FIG. 6 is an example 600 of a machine learning algorithm for context detection in accordance with some embodiments. The support document text 610 and metadata are loaded from the respective databases. The text 610 is cleaned and an occurrence of a support document number 612 is detected. For every detection of such a number 612, the relevant text part 620 around the number 612 is extracted. This text part 620 is used in the next step for the analysis of the semantic context. The text 620 is tokenized and converted into a word vector 630 (note that the document number may be made generic 632) for input to the machine learning algorithm. Some embodiments use a bag of words approach where a vocabulary of N words is mapped to a vector 630 with N dimensions, and the value for every dimension indicates how often the corresponding word occurs in the input text 620. These word vectors 630 are combined with the additional note metadata as input data for the training block. A similar approach is used to create input for the the inference block.

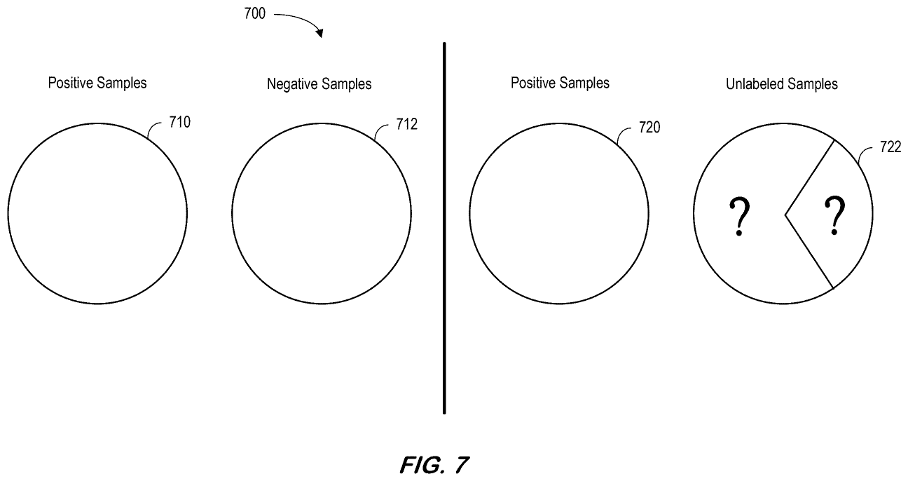

For the supervised training of the machine learning model, labelled training data may be used. Fortunately, the majority of all support documents have correctly maintained side effect links. Hence, these links (available as support document metadata) can be employed as labels for the training. From this training set, the machine learning algorithm can be trained to determine if a given text part indicates that the mentioned number is relevant for a side effect link (or not relevant). This analysis of the context may help filter out other possible occurrences of numbers in the text of support documents. For example, there are various contexts where a document number might occur (e.g., when referring to additional information included in another note or when referring to a feature included in another document). Furthermore, may be numbers in the document text that are not document numbers at all. Using the side-effect link that is maintained in the database as a label for training, however, involves the risk that the data will also contain some fraction of documents with missing side effect links. FIG. 7 illustrates 700 machine learning training data according to some embodiments. In some cases, the input data may include positive samples 710 and negative samples 712. In other cases, the input data includes positive samples 720 and unlabeled samples 722. When only the “positively” labeled document with a side effect link are reliably labeled, all documents without a side effect link are “unlabeled” instead of “negative.” This type of dataset is commonly referred to as Positive and Unlabeled (“PU”) data.

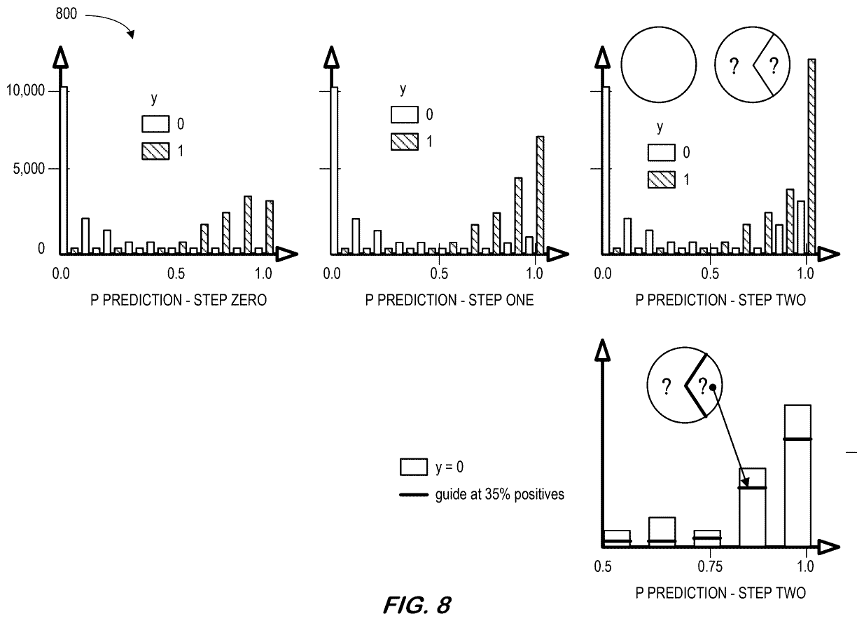

The PU data effectively introduces class noise into a negative training dataset which can be mitigated by a multi-step training approach. FIG. 8 illustrates 800 machine learning via consecutive training steps in accordance with some embodiments. By using the inference results of the first training round, the training dataset can be refined by dropping the fraction of the unlabeled dataset where the probability of belonging to the positive class is largest. Next, consecutive training is done on the refined training dataset. This is repeated two times to reduce the influence of class noise. After applying this multi-step approach, the positive and negative fraction become distinguishable in the probability distribution of the unlabeled data. The distinct peak at large probabilities can result from notes that do not have a side effect link maintained on the database but that do mention another note in a context that points towards a missing side effect link. These are the missing side effect links that the system should detect. The trained machine learning algorithm is used to calculate probabilities for each unlabeled document that contain a missing link. Selecting all datasets with a probability larger than a threshold value generates a list of candidate support documents for further review.

The exact threshold value can be adjusted manually. This provides the opportunity to fine tune the number of proposed candidates. Choosing a smaller threshold will result in more candidates for review and reduce the risk of undetected missing links. In contrast, a larger threshold value will reduce the total number of candidates but increase the risk of undetected missing links.

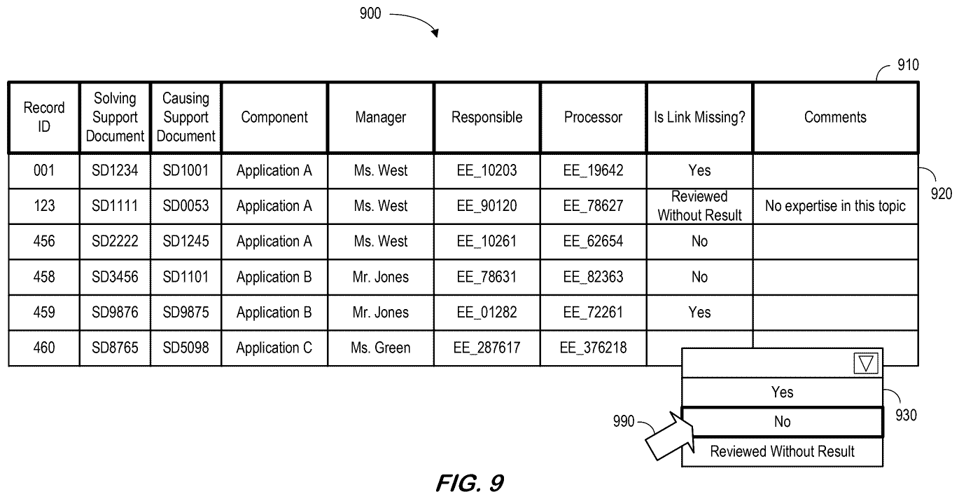

An expert such as a software developer can then review and update the documents in the candidate database. For example, the detected candidates may be enriched with administrational metadata and then converted into a report or list which is used by the developers during the manual review process. This list can serve as a work list for the developer and capture the expert feedback from the developer. FIG. 9 is a missing link report 900 according to some embodiments. The report 900 includes a table 910 with rows 920 that list potential candidates that might have missing links. The table 910 may then be updated by a developer after the appropriate documents have been reviewed. The table 910 includes columns for a record identifier, a solving support document (which may have a missing link), a causing support document, a software component, a manager, a responsible employee (author of the document), a processor employee (reviewer of the document), an indication if a link is missing, and comments. According to some embodiments, the table 910 columns can be used for sorting or filtering.

Selection of a row 920 by a developer (e.g., by a touchscreen or computer mouse pointer 990) results in a popup window 930 that can be used to provide feedback if the missing side effect was detected correctly (“Yes”), if the missing link was a false positive (“No”), or if the review did not reach a conclusion. The optional “Comment” column may be used for exceptional cases that need additional explanation. The developer may indicate “Yes” (missing link), for example, when the causing document introduces a bug and the solving document provides a fix for that bug. Similarly, “Yes” may be selected when the causing document fixes an issue but does not take into account a special case, and the solving document provides a fix for this issue in the special case. The developer may indicate (“No”) (not a missing link), for example, when a support document mentions another document because it contains additional information about the topic or it provides a fix for the same issue for another product or release. If the developer would generally advise a customer to implement one document when implementing another document in response to a customer incident, it is useful to set the side effect link. When the side effect link exists, this recommendation to implement note B can then be given to all customers proactively.

The updated side effect link is now available for various other processes which rely on this relation. Internally, the causing and solving document relation may be displayed clearly when viewing the note (and before the missing link was detect this information was hidden in the note text). The link may also be used for support document implementation recommendations to customers which foster the implementation of bug fixes. This helps provide relevant recommendations to customers and proactively prevent customer issues.

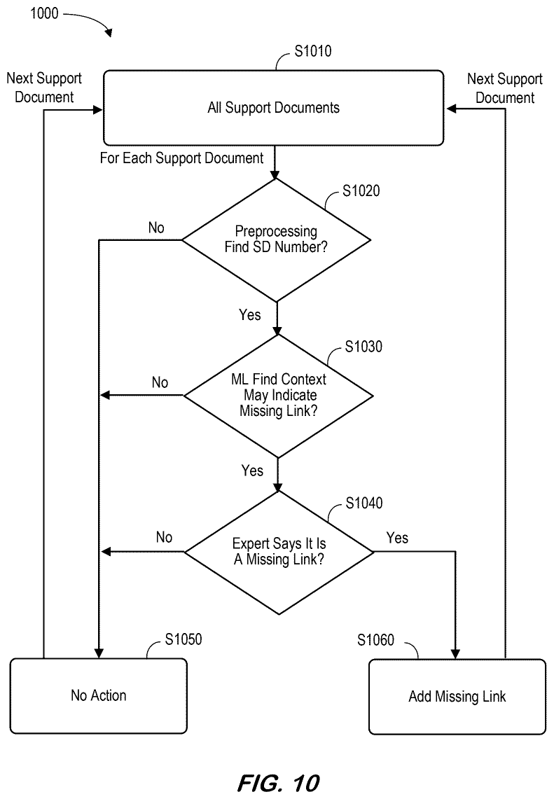

FIG. 10 is a missing link workflow 1000 in accordance with some embodiments. The workflow 100 begins with the pool of all support documents at S1010. For each document in the pool, it is determined by preprocessing if the text of that document refers to another support document number at S1020. If not, no action is taken at S1050 and the next support document is evaluated. If it does refer to another support document number at S1020, machine learning is used at S1030 to determine if the context indicates a missing link. If not, no action is taken at S1050 and the next support document is evaluated. If does indicate a potential missing link at S1030, an expert is consulted at S1040 to determine if it is actually a missing link. If not, no action is taken at S1050 and the next support document is evaluated. If the expert indicates it is really a missing link, then the missing link is added at S1060 and the next document is evaluated (until all support documents are completed).

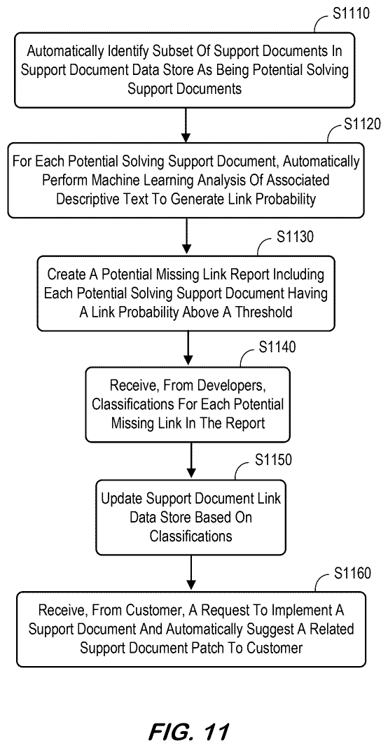

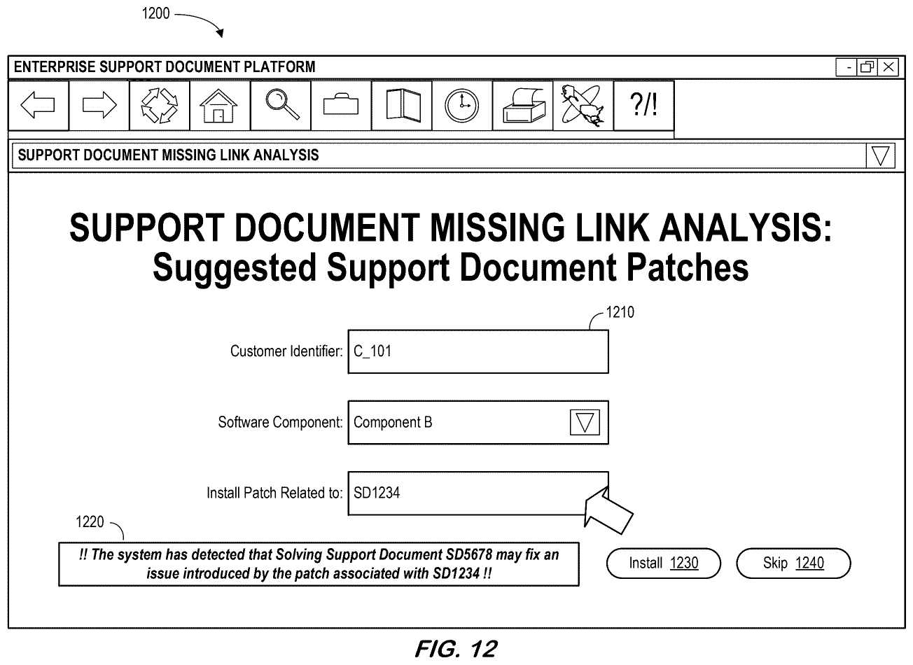

According to some embodiments, the supporting document link data store is used to automatically suggest a related support document patch to a customer. For example, FIG. 11 is a customer suggestion method according to some embodiments. At S1110, a subset of support documents in a support document data store is automatically identified as being potential solving support documents. For each potential solving support document, at S1120 the system may automatically perform a machine learning analysis of the associated descriptive text to generate a link probability. For all potential solving support documents having a link probability above a threshold, at S1130 the system may automatically generate a potential missing link report. At S1140, these are manually reviewed by software developers and classified. At S1150, a support document link data store is updated with the classifications. When a customer later requests to implement a patch for a support document, the system may automatically suggest a related support document patch to the customer at S1160. For example, FIG. 12 is a customer suggestion display 1200 in accordance with some embodiments. The display 1200 includes information 1210 identifying a customer, a software component, and a request to install a patch related to a support document. The system can then use this information and a support document link data store to automatically suggest a related patch 1220 (and the customer can decide to “Install” the patch 1230 or “Skip” installation 1240).

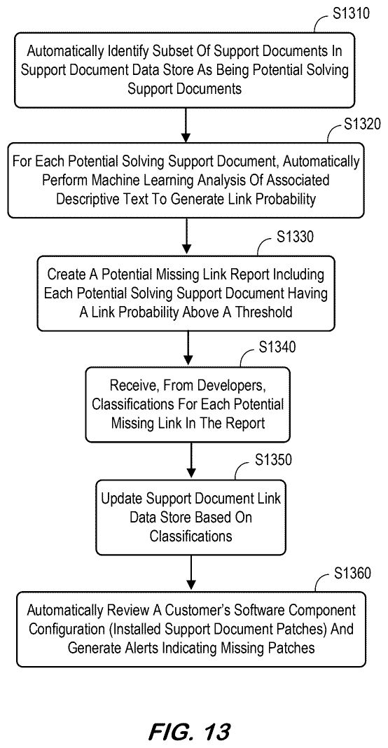

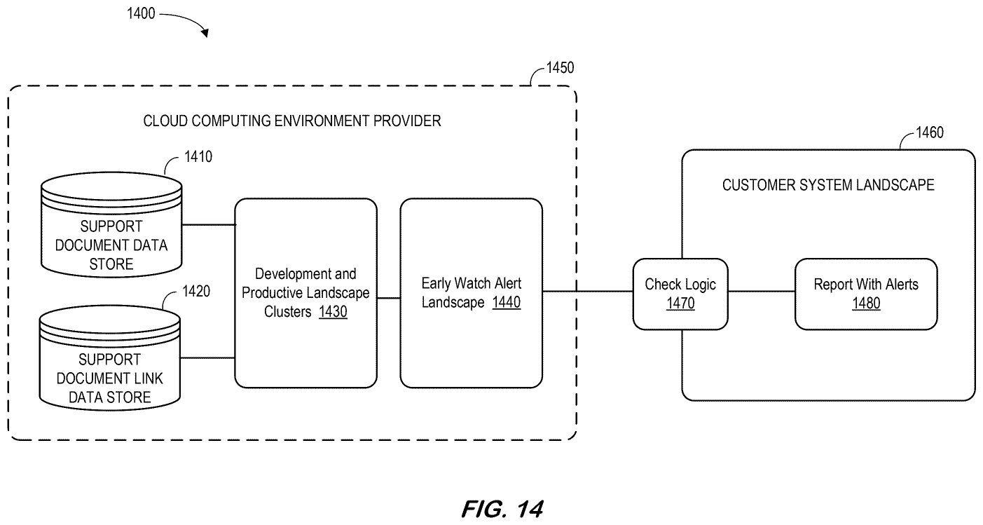

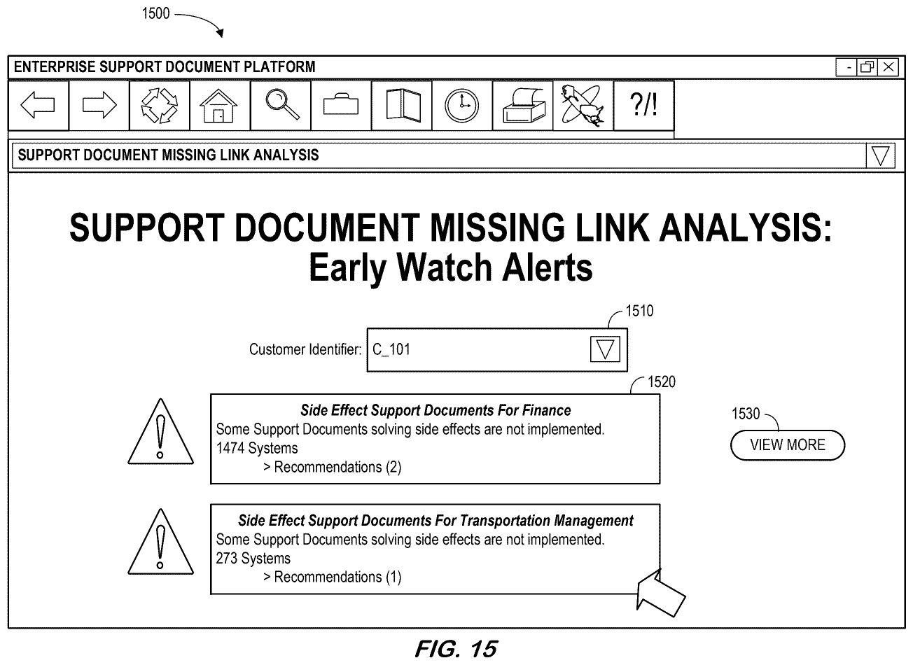

According to other embodiments, the supporting document link data store is used to automatically review a customer's installed support document patches and generate alerts indicating missing patches. For example, FIG. 13 is a customer landscape alert method according to some embodiments. At S1310, a subset of support documents in a support document data store is automatically identified as being potential solving support documents. For each potential solving support document, at S1320 the system may automatically perform a machine learning analysis of the associated descriptive text to generate a link probability. For all potential solving support documents having a link probability above a threshold, at S1330 the system may automatically generate a potential missing link report. At S1340, these are manually reviewed by software developers and classified. At S1350, a support document link data store is updated with the classifications. A customer's software component configuration (including implemented patches) can then be evaluated and the system may automatically generate alerts showing related support document patches to the customer that are missing from the configuration at S1360. FIG. 14 is a customer landscape alert architecture 1400 in accordance with some embodiments that might implement this method. A cloud computing environment provider 1450 may execute development and productive landscape clusters 1430 that accesses a support document data store 1410 and a support document link data store 1420. An actual productive landscape cluster may communicate with an early watch alert landscape 1440 that checks logic 1470 in connection with a customer system landscape 1460. A report with alerts 1480 may then be provided to the customer. For example, FIG. 15 is a customer landscape alert display 1500 according to some embodiments. The display 1500 includes information 1510 identifying a customer. The system can then use this information and a support document link data store to automatically generate alerts, warnings and/or recommendations 1520 for the customer (and the customer can decide to “View More” alerts 1530).

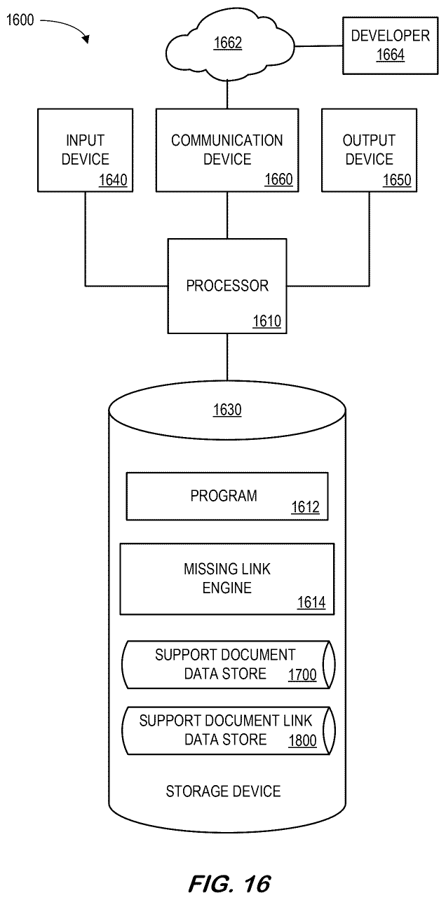

Note that the embodiments described herein may be implemented using any number of different hardware configurations. For example, FIG. 16 is a block diagram of an apparatus or platform 1600 that may be, for example, associated with the system 300 of FIG. 3 (and/or any other system described herein). The platform 1600 comprises a processor 1610, such as one or more commercially available Central Processing Units (“CPUs”) in the form of one-chip microprocessors, coupled to a communication device 1660 configured to communicate via a communication network 1662. The communication device 1660 may be used to communicate, for example, with one or more remote developers 1664, administrator platforms, etc. The platform 1600 further includes an input device 1640 (e.g., a computer mouse and/or keyboard to input mappings and/or machine learning algorithm information) and/or an output device 1650 (e.g., a computer monitor to render a display, transmit recommendations and alerts, and/or create reports about customers, components, support documents, missing links, etc.).

The processor 1610 also communicates with a storage device 1630. The storage device 1630 may comprise any appropriate information storage device, including combinations of magnetic storage devices (e.g., a hard disk drive), optical storage devices, mobile telephones, and/or semiconductor memory devices. The storage device 1630 stores a program 1612 and/or missing link engine 1614 for controlling the processor 1610. The processor 1610 performs instructions of the programs 1612, 1614, and thereby operates in accordance with any of the embodiments described herein. For example, the processor 1610 may automatically identify some support documents as being potential solving support documents. For each potential solving support document, a machine learning analysis of the descriptive text is performed to generate a link probability. For each document having a link probability above a threshold, the processor 1610 may automatically generate a potential link message that includes the document identifier and an associated causing support document identifier. According to some embodiments, potential link messages are compiled by the processor 1610 into a potential link report for review by a developer to classify them as an actual link or not an actual link. A support document link data store may then be updated by the processor 1610 with indications of causing support documents and associated links to solving support documents.

The programs 1612, 1614 may be stored in a compressed, uncompiled and/or encrypted format. The programs 1612, 1614 may furthermore include other program elements, such as an operating system, clipboard application, a database management system, and/or device drivers used by the processor 1610 to interface with peripheral devices.

As used herein, information may be “received” by or “transmitted” to, for example: (i) the platform 1600 from another device; or (ii) a software application or module within the platform 1600 from another software application, module, or any other source.

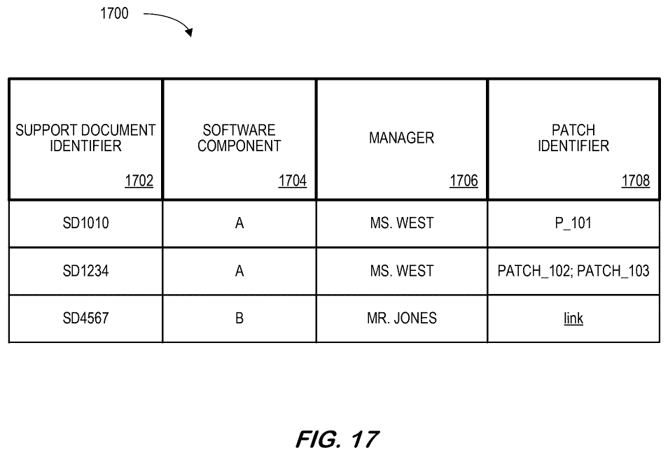

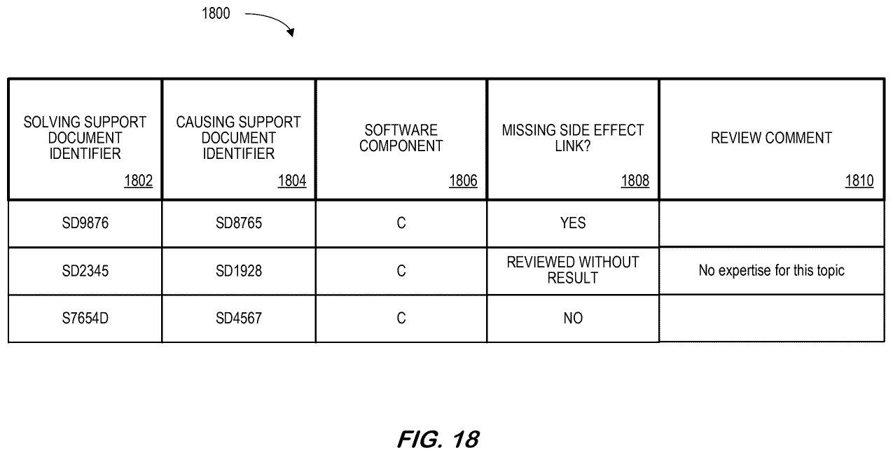

In some embodiments (such as the one shown in FIG. 16), the storage device 1630 further stores support document data store 1700 and a support document link data store 1800. Examples of databases that may be used in connection with the platform 1600 will now be described in detail with respect to FIGS. 17 and 18. Note that the databases described herein are only examples, and additional and/or different information may be stored therein. Moreover, various databases might be split or combined in accordance with any of the embodiments described herein.

Referring to FIG. 17, a table is shown that represents the support document data store 1700 that may be stored at the platform 1600 according to some embodiments. The table may include, for example, entries identifying support documents associated with software component support. The table may also define fields 1702, 1704, 1706, 1708 for each of the entries. The fields 1702, 1704, 1706, 1708 may, according to some embodiments, specify: a support document identifier 1702, a software component 1704, a manager 1706, and a patch identifier 1708. The support document data store 1700 may be created and updated when a new document is added or updated, an expert review is performed, etc.

The support document identifier 1702 might be a unique alphanumeric label that is associated with a particular support document (including a support document number and associated descriptive text. The software component 1704 identifies the application component associated with the support document identifier 1702, and the manager 1706 identifies a party responsible for that component. The patch identifier 1708 may include or point to software corrections or updates.

Referring to FIG. 18, a table is shown that represents the support document link data store 1800 that may be stored at the platform 1600 according to some embodiments. The table may include, for example, entries identifying links or relationships between support documents. The table may also define fields 1802, 1804, 1806, 1808, 1810 for each of the entries. The fields 1802, 1804, 1806, 1808, 1810 may, according to some embodiments, specify: a solving support document identifier 1802, a causing support document identifier 1804, a software component 1806, a missing side effect link indication 1808, and a review comment 1810. The support document link data store 1800 may be created and updated, for example, when new links are identified, a review has been performed by an expert developer, etc.

The solving support document identifier 1802 might be a unique alphanumeric label that is associated with a particular support document that corrects a side effect. The causing support document identifier 1804 identifies the document that introduced the side effect or bug, and the software component 1806 indicates the application component associated with those document identifiers 1802, 1804. The missing side effect link indication 1808 is supplied by an expert developer and might indicate that the documents do reflect a missing link, do not reflect a missing link, or that no result could be determined (e.g., which might be further explained by the review comment 1810.

In this way, embodiments may be used to recommend support documents to customers that may be relevant for implementation. This may reduce the number of missing side effect links that impair timely implementation of bug fixes in the customer system. Moreover, embodiments may use machine learning to automatically identify notes where it is likely that a side effect link is missing. Updating these missing links can facilitate support document patch implementation and improve the data quality of the support document data store. This helps to reduce the number of customer tickets (for already known issues) by proactively promoting the implementation of a solution before an issue occurs.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

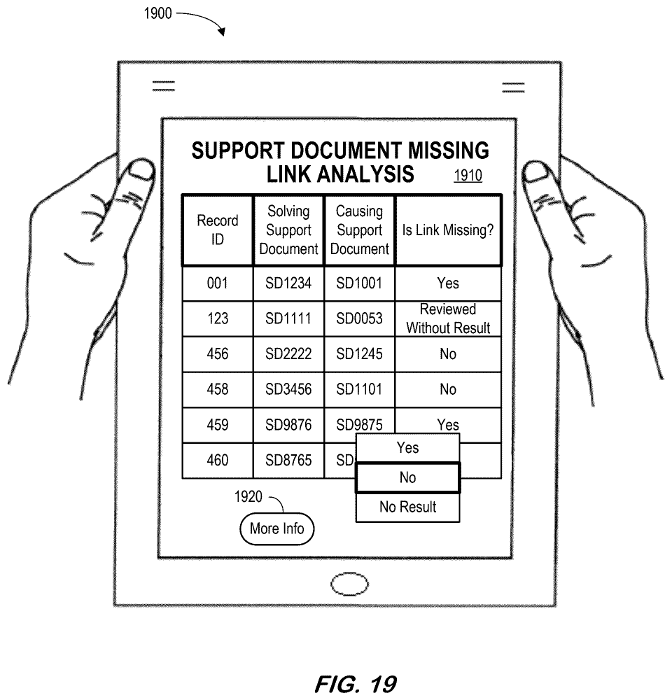

Although specific hardware and data configurations have been described herein, note that any number of other configurations may be provided in accordance with some embodiments of the present invention (e.g., some of the information associated with the databases described herein may be combined or stored in external systems). Moreover, although some embodiments are focused on particular types of support documents and missing links, any of the embodiments described herein could be applied to other types of documents and links. Moreover, the displays shown herein are provided only as examples, and any other type of user interface could be implemented. For example, FIG. 19 illustrates a tablet computer 1900 providing a support document missing link analysis display 1910. The display 1910 might be used, for example, to modify aspects of a missing link database or table, etc. via selection of a “More Info” icon 1920.

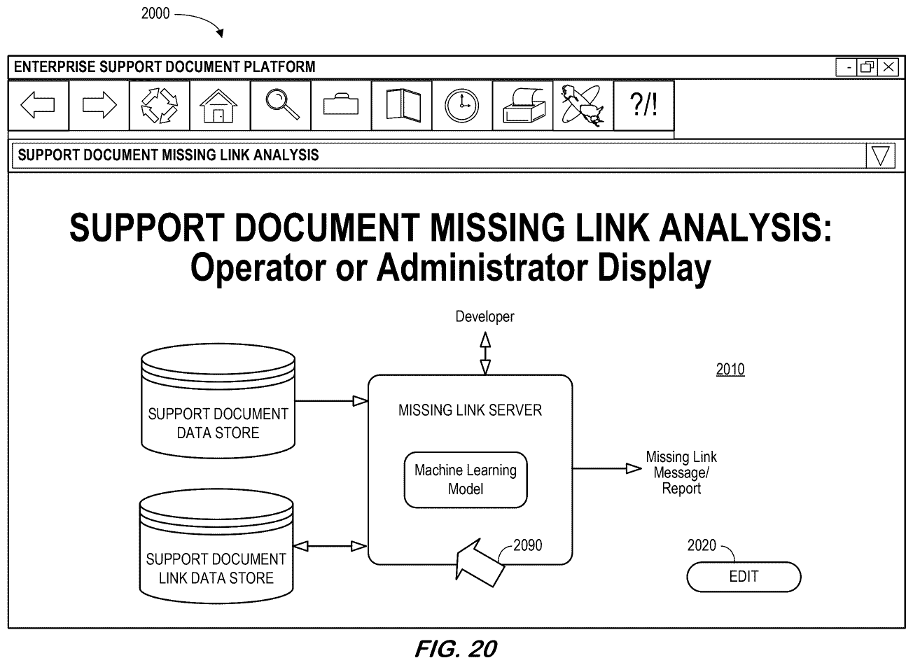

FIG. 20 is an operator or administrator display in accordance with some embodiments. The display 2000 includes a graphical representation 2010 of a missing link analysis system in accordance with any of the embodiments described herein. Selection of an element on the display 2000 (e.g., via a touchscreen or computer pointer 2090) may result in display of a popup window containing more detailed information about that element and/or various options (e.g., to enter machine learning parameters, expert decisions, etc.). Selection of an “Edit” icon 2020 may also let an operator or administrator adjust the operation of the system (e.g., to change system mappings, adjust a missing link probability threshold, etc.).

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

1. A system associated with software component support, comprising:
a support document data store containing a plurality of support documents for at least one software component, each support document including a support document identifier and descriptive text describing the support document; and
a missing link server, coupled to the support document data store and the support document link data store, including:
a computer processor, and
a computer memory storing instructions that, when executed by the computer processor, cause the missing link server to:
automatically identify a subset of the support documents in the support document data store as being potential solving support documents,
for each potential solving support document, automatically perform a machine learning analysis of the associated descriptive text to generate a link probability, and
for each potential solving support document having a link probability above a threshold, automatically generate a potential link message that includes the potential solving document identifier and an associated causing support document identifier.

2. The system of claim 1, wherein identification of the potential solving support documents comprises detection of at least one support document identifier in the descriptive text.

3. The system of claim 1, wherein at least some of the support documents in the support document data store further include information about a software patch for the at least one software component.

4. The system of claim 3, wherein a solving support document includes information about a software patch to be installed for a software application after a patch associated with an associated causing support document is installed.

5. The system of claim 2, wherein a plurality of potential link messages are compiled into a potential link report for review by a developer.

6. The system of claim 5, wherein the review by the developer classifies each potential link as one of: (i) an actual link, (ii) not an actual link, and (iii) unresolved.

7. The system of claim 6, further comprising:
a support document link data store including indications of causing support document identifiers and, for each causing support document identifier, an associated link to a solving support document identifier, wherein the potential link classification is used to automatically update the support document link data store,
wherein the classifications are used to automatically update the support document link data store.

8. The system of claim 7, wherein the support document link data store further stores software component identifiers, support document author identifiers, and reviewing developer identifiers.

9. The system of claim 7, wherein the supporting document link data store is used to automatically suggest a related support document patch to a customer.

10. The system of claim 7, wherein the supporting document link data store is used to automatically review a customer's installed support document patches and generate alerts indicating missing patches.

11. The system of claim 7, wherein the machine learning analysis is performed by a model trained with potential links classified by developers.

12. The system of claim 11, wherein the model utilizes selected relevant text extracted from the descriptive text of the potential solving support document with the detected support document identifier removed.

13. The system of claim 12, wherein classifications are used as feedback to adjust and improve the model.

14. A computer-implemented method associated with software component support, comprising:
automatically identifying, by a computer processor of a missing link server, a subset of support documents in a support document data store as being potential solving support documents, wherein the support document data store contains a plurality of support documents for at least one software component, each support document including a support document identifier and descriptive text describing the support document;
for each potential solving support document, automatically performing a machine learning analysis of the associated descriptive text to generate a link probability;
for each potential solving support document having a link probability above a threshold, automatically generating a potential link message that includes the potential solving document identifier and an associated causing support document identifier;
compiling a plurality of potential link messages into a potential link report for review by a developer, wherein the review by the developer classifies each potential link as one of: (i) an actual link, (ii) not an actual link, and (iii) unresolved; and
using the classifications to automatically update a support document link data store, wherein the support document link data store includes indications of causing support document identifiers and, for each causing support document identifier, an associated link to a solving support document identifier, wherein the potential link classification is used to automatically update the support document link data store.

15. The method of claim 14, wherein the supporting document link data store is used to automatically suggest a related support document patch to a customer.

16. The method of claim 14, wherein the supporting document link data store is used to automatically review a customer's installed support document patches and generate alerts indicating missing patches.

17. The method of claim 14, wherein the machine learning analysis is performed by a model trained with potential links classified by developers and the model utilizes selected relevant text extracted from the descriptive text of the potential solving support document with a detected support document identifier removed.

18. One or more non-transitory computer-readable media storing computer-executable instructions that, when executed by a computing system, cause the computing system to perform operations comprising:
automatically identifying, by a computer processor of a missing link server a subset of support documents in a support document data store as being potential solving support documents, wherein the support document data store contains a plurality of support documents for at least one software component, each support document including a support document identifier and descriptive text describing the support document;
for each potential solving support document, automatically performing a machine learning analysis of the associated descriptive text to generate a link probability; and
for each potential solving support document having a link probability above a threshold, automatically generating a potential link message that includes the potential solving document identifier and an associated causing support document identifier.

19. The media of claim 18, wherein identification of the potential solving support documents comprises detection of at least one support document identifier in the descriptive text.

20. The media of claim 18, wherein the machine learning analysis is performed by a model that utilizes selected relevant text extracted from the descriptive text of the potential solving support document with the detected support document identifier removed.
